(19) United States
(12) Patent Application Publication
(10) Pub. No.: US 2007/0300280 A1
(43) Pub. Date: Dec. 27, 2007

(54) INTERACTIVE METHOD OF ADVERTISING

(75) Inventors: Gary Turner, Parker, CO (US); Douglas E. McGary, Castle Rock, CO (US)

Correspondence Address: SHERIDAN ROSS PC, 1560 BROADWAY, SUITE 1200, DENVER, CO, 80202, US

(73) Assignee: TURNER MEDIA GROUP, Glendale, CO (US)

(21) Appl. No.: 11/425,652

(22) Filed: Jun. 21, 2006

(51) Int. Cl. H04N 7/16

(52) U.S. Cl. 725/135; 725/136

(57) ABSTRACT

Methods and apparatuses for providing enhanced advertising media are described herein. In particular, interactive advertisements may be presented to a user through a display apparatus like a television. The user may be able to navigate the interactive media by selecting triggers and/or utilizing a navigation bar while continuing to view the live broadcast that is being shown to him/her.

### FIELD

The present invention is directed to interactive media. In particular, the present invention is directed to methods and apparatuses providing a television or multimedia device viewer with interactive advertisements and other programming that may be personalized for the given viewer.

### BACKGROUND

The technology of Interactive Television (ITV) has been developed in an attempt to allow a television (TV) set to serve as a two-way information distribution mechanism. Features of an ITV accommodate a variety of marketing, entertainment, and educational capabilities such as allowing a user to order an advertised product or service, compete against contestants in a game show, and the like. Typically, the interactive functionality is controlled by a “set-top” decoder box (“set-top box” or “STB”), which executes an interactive program written for the TV broadcast. The interactive functionality is often displayed on the TV's screen and may include icons or menus to allow a user to make selections via the TV's remote control or a keyboard.

The program interactivity may be optional. Thus, a user who chooses not to interact or who does not have interactive functionality included with the user's TV should not suffer any degradation or interruption in program content. In order to provide this option to users, a transparent method of incorporating interactive content into the broadcast stream that carries the program is employed. In the present disclosure, “broadcast stream” or “live broadcast” refers to the broadcast signal, whether analog or digital, regardless of the method of transmission of that signal, i.e. by antenna, satellite, cable, or any other method of analog or digital signal transmission.

One method of transparently incorporating interactive content into the broadcast stream is the insertion of triggers into the broadcast stream for a particular program. The insertion of triggers into a broadcast stream is well known in the art. Program content in which such triggers have been inserted is sometimes referred to as enhanced program content or as an enhanced TV program or video signal.

Triggers may be used to alert a STB that interactive content is available. The trigger may contain information about available enhanced content as well as the memory location of the enhanced content. A trigger may also contain user-perceptible text that is displayed on the screen, for example, at the bottom of the screen, which may prompt the user to perform some action or choose amongst a plurality of options. Thus, a user with a TV that has interactive functionality may be prompted at the beginning of an enhanced TV program to choose between interactive and passive (non-interactive) viewing of the enhanced TV program. If the user chooses passive viewing, any further triggers contained in the enhanced TV program may be ignored by the STB and the user will view the program in a conventional way. However, if the user chooses the interactive option, then further triggers may be embedded in the enhanced TV program.

Triggers may be inserted into the broadcast stream at various points along the broadcast path. Triggers may be inserted into the broadcast stream before broadcast of the content by a broadcast station or any other media provider. Thus, these triggers would be part of the broadcast stream received by cable head ends and further distributed to TVs within homes. TVs are provided with interactive functionality by their associated STBs.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a TV screen. Such closed caption decoders process the text data separately from the video signal.

The Advanced Television Enhancement Forum (ATVEF) has defined protocols for Hypertext Markup Language (HTML)-based enhanced TV. These protocols allow the delivery of enhanced TV programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced TV program. ATVEF-A triggers comprise a universal Resource Locator (URL), which provides an Internet address from which interactive content may be downloaded, whereas ATVEF-B triggers themselves can contain interactive content.

While the advent of ATVEF triggers have provided a gateway to interactive television, the complete utilization of ITV and enhanced TV has not been fully realized. For example, most media that is provided to a user during periods of interactivity may not necessarily be customized to that user. More specifically, the interactive content provided to the user is sent to the STB without making a determination about the user's preferences and taste. Furthermore, the way a user interacts with content is somewhat limited in that only certain triggers are presented to the user at a particular time. Thus, the number of options available to the user is limited by the content they are currently viewing. A further shortcoming of ITV is that multiple interactions on the same screen are not permitted. In other words, the user is presented with a single content that he/she can interact with. The user is not able to interact with a number of different contents at the same time. Accordingly, there exists a need in the art for a more complete ITV and enhanced TV solution that overcomes the above-noted shortcomings.

### SUMMARY

The present invention is directed to solving these and other problems and disadvantages of the prior art. In accordance with embodiments of the present invention, a method for administering interactive media to a user is provided. Specifically, the method comprises the steps of:

presenting a first trigger to the user, wherein the first trigger is associated with a first content;

receiving a request to view the first content by actuation of the first trigger;

causing the first content to be presented to the user;

presenting a second trigger to the user within the first interactive content, wherein the second trigger is associated with a second content;

receiving a request to view the second content by actuation of the second trigger; and

causing the second content to be presented to the user at substantially the same time as the first content.

It is a further aspect of the present invention to provide a system for administering interactive media to a user, comprising:

a receiver operable to receive broadcast signals and a first trigger associated with a first content, wherein the first content further comprises a second trigger associated with a second content; and

a display apparatus operable to display a user-perceptible form of the first and second content at substantially the same time in response to the receiver receiving a request from the user to view the first and second content, whereby the request is received by actuation of the first and second triggers.

As used herein “content” includes any type of user-perceptible substance that can incorporate visual and/or audio media. Content is typically in the form of video media or static pages that can be viewed on a TV or the like by a user. Examples of content include, but are not limited to, a live broadcast that may be received from a satellite provider, a cable provider, or over free air, a short form advertisement for a particular product and/or service, a long form advertisement for a particular product and/or service, and one or more static viewable pages related to a particular product and/or service.

As can be appreciated by one of skill in the art, the content may simply be supplied to a particular user without determining any information about the user or the type of television show that the user is currently watching. Alternatively, content may be personalized and supplied to a user after a determination of information about that user has been made. This information may be related to gender, entertainment activity, demographics, personal income, or numerous other factors. Additionally, content may be provided to a user in response to the type of television show or commercial that the user is viewing. For example, a user watching a fishing show may be presented a trigger that can redirect the user to another content that is related to fishing (i.e., a short or long form advertisement for fishing supplies).

Content may be further defined by type. In other words, the type of content for the broadcast noted above could be fishing, outdoors, sports, or the like. As used herein, the “type of content” is used to refer to the actual substance or subject matter that the content is directed toward. The type of content of a short form advertisement for a car may be automotive, sports car, family car, or the like. The type of content may be a particular genus of products and/or services like automotive. Alternatively, the type of content may be more specific to a species of the genus of automotives like pick-up truck dealers.

In accordance with one embodiment of the present invention, multiple contents can be displayed to a user at substantially the same time. This particular feature affords the user the opportunity to selectively view one or more contents and to choose which content of the simultaneously presented contents the user would like to continue viewing. In other words, a user may be presented two contents at substantially the same time. Both contents may be related to the same type of content (i.e., both contents are directed toward printers). The first content may be a short form advertisement for the printer, whereas the second content may be a long form advertisement for the same printer. The user is able to view both contents at substantially the same time and then can make a decision as to which content, if any, he/she would like to watch further. If the user is very interested in the printer, then the user may choose the long form advertisement of the printer. Whereas if the user is only somewhat interested in the printer, then the user may choose to view the short form advertisement. One of the two contents may also be static pages or the like that can be personalized for the user based on his/her location, areas of previously determined interest, user information, and the like. The user may then be able to navigate the static pages in an attempt to find a printer dealer that is close to him/her.

A user may be able to select a different trigger that changes one of the advertisement contents back to the live broadcast content. The user can continue to view the program that he/she was previously watching but may also be able to continue viewing one of the advertisements that peaked his/her interest.

Additionally, the actions of a user can be monitored such that additional information about the user can be determined and used to enhance a later ITV session. For example, by monitoring actions of a user it may be determined that the user is particularly interested in jewelry. Based on this determination, the types of content or the triggers associated with such content that are presented to the user at a later time may be optimized to show the user more content that is related to jewelry or similar products/services.

Another feature offered by the present invention is that the activity of a number of users may be monitored with respect to a particular type or brand of content. More specifically, trigger counts for a single content can be tallied for a number of users. The summation of all trigger activity for the selected content can then be provided to a company or the like associated with the selected content. For example, a company may launch an advertising campaign using methods described herein that include long and short form advertisements for a new car. As different users select triggers associated with the content of the advertising campaign, the trigger selection by all users can be tallied and provided as feedback to company. This feedback is useful to the car manufacturer in that the marketing department can make a very accurate determination of the number of people that have actually viewed their advertisements. The company may further be able to make an accurate determination of the number of sales that resulted from the advertisement campaign due to the navigation of the static pages and subsequent car purchases at related dealers.

Advertising campaigns in the past simply put a sign or advertisement up for anyone to see, but most companies cannot make a very accurate determination of the number of people that actually paid attention to the advertisement. For example, just because a person has his/her TV on when a commercial appears does not mean that the person viewed that commercial. The user may have been out of the room when the commercial was presented. Unfortunately, it was previously very difficult to make an accurate determination of the number of viewers of an advertisement. However, when a trigger is activated or otherwise selected by a user, it can be stated with much more confidence that the user has actually viewed the advertisement associated with the trigger.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a broadcast and display system in accordance with embodiments of the present invention;

FIG. 2 is a screen shot depicting a broadcast along with a trigger to interactive advertising media in accordance with embodiments of the present invention;

FIG. 3 is a screen shot depicting a short advertisement with triggers to additional media in accordance with embodiments of the present invention;

FIG. 4 is a screen shot depicting a three-quarters presentation of a short advertisement along with static information in accordance with embodiments of the present invention;

FIG. 5 is a screen shot depicting a three-quarters presentation of a long advertisement along with a short advertisement in accordance with embodiments of the present invention;

FIG. 6 is a screen shot depicting a three-quarters presentation of a broadcast along with an advertisement navigation screen in accordance with embodiments of the present invention;

FIG. 7 is a screen shot depicting a three-quarters presentation of a broadcast along with personalized static pages in accordance with embodiments of the present invention;

FIG. 8 is a flow diagram depicting a method of presenting interactive media to a user in accordance with embodiments of the present invention;

FIG. 9 is a flow diagram depicting a method of determining user related information in accordance with embodiments of the present invention; and

FIG. 10 is a flow diagram depicting a method of monitoring activity associated with a selected content in accordance with embodiments of the present invention.

### DETAILED DESCRIPTION

Embodiments of the present invention are generally directed toward methods and systems for administering ITV and creating an enhanced TV viewing experience. Although well suited for use with a television or similar type of display apparatus in conjunction with a STB, those skilled in the art can appreciated that embodiments of the present invention may also be implemented in conjunction with personal digital assistants (PDAs), mobile phone devices, and the like. Moreover, the systems and methods described in the present disclosure may be implemented in any media that may be enhanced through the use of events including, but not limited to, triggers that are synchronized to user-perceptible segments in a broadcast or other type of content.

As used herein “viewer” and “user” are used synonymously to refer to any person or thing that is currently making use of and/or interacting with the enhanced television system.

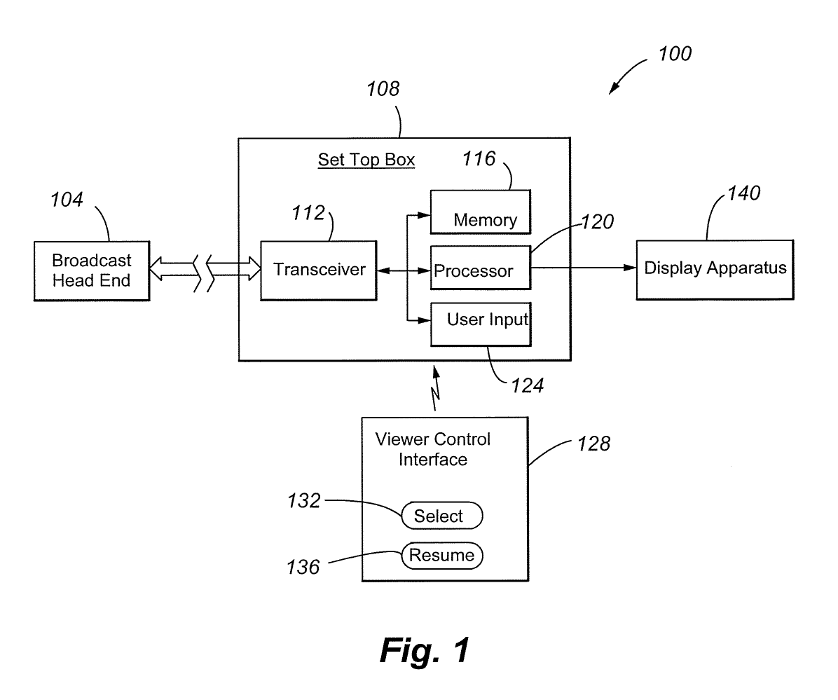

Referring now to FIG. 1 one embodiment of a hardware system 100 for providing interactive media will be described in accordance with embodiments of the present invention. The system 100 generally comprises a broadcast head end 104, a Set Top Box (STB) 108 comprising a transceiver 112, a memory 116, a processor 120, and a user input 124, a user control interface 128 comprising a select button 132 and a resume button 136, and a display apparatus 140. The broadcast head end 104 may be associated with one or more servers that provide information to and receive information from the broadcast head end 104. Information that may be provided to the broadcast head end 104 includes live broadcast signals, triggers, content related to the triggers, and other streaming or non-streaming video and audio media.

The processor 120 may be implemented as a microprocessor or similar type of processing chip. The processor 120 may complete executable instructions or routines stored in a portion of memory 116. Alternatively, the processor 120 may be implemented in the form of an application specific integrated circuit (ASIC) that is operable to perform predefined functions based on predetermined inputs. The processor 120 generally functions to run programming code including operating system software, and one or more applications implementing various functions performed by the STB 108.

The memory 116 may be implemented as a volatile or non-volatile memory, or combinations thereof. For example, the memory 116 may comprise a temporary or long-term storage of data or processor instructions. The memory 116 may be used in connection with the presentation of enhanced content to a viewer. The memory 116 may comprise solid-state memory resident, removable or remote in nature, such as DRAM, SDRAM, ROM, and EEPROM.

The user input 124 may comprise a receiver for communicating with the viewer control interface 128. The user input 124 may also comprise a keyboard, mouse, or the like such that the user can navigate content presented to him/her in a similar manner to navigating content on a computer.

The STB 108 is operable to communicate with the broadcast head end 104 via the transceiver 112. The transceiver 112 is essentially the interface to the head end 104 for the STB 108. The transceiver 112 may comprise a coaxial cable connection, a USB port or other type of serial port, a modem, an Ethernet adapter, a satellite adapter, or the like. Content received at the transceiver 112 is communicated to the processor 120 and/or the memory 116. Content that may be transmitted to the STB 108 includes, but is not limited to, live broadcasts from cable, satellite, or radio waves, short form advertisements, long form advertisements, static pages, customized advertisements, customized static pages, other commercials, and the like. Typically, short form advertisements, long form advertisements, static pages, and other enhanced commercial content is stored in the memory 116 when they are received at the transceiver 112. The content is typically stored in a particular address of the memory such that it can be easily retrieved at a later time. In normal operation, content is sent to the STB 108 during idle periods (i.e., when the user is not viewing a live broadcast). However, content can also be sent to the STB 108 during a live broadcast through one or more vertical blanking intervals (VBIs) as packets of information that can be stored in memory 116 while the live broadcast is being displayed.

A trigger usually contains an address, pointer, or some other sort of reference to the stored content or a live broadcast. When a user activates a trigger during a broadcast, the processor 120 uses the address of stored content associated with the trigger to retrieve the content from memory 116. In the event that the content associated with the trigger is a live broadcast, then the trigger references the channel where the live broadcast can be found. Subsequently, the content can be displayed to a user via the display apparatus 140. Thus, multiple pre-stored contents can be maintained in the memory 116 for later display at the appropriate time or a user can navigate multiple live contents via triggers.

Generally, a trigger is transmitted along with a broadcast and both are displayed to a user via the display apparatus 140. A user is able to select the displayed trigger by pressing the select button 132 on the viewer control interface 128. The command to view content associated with the displayed trigger is received at the user input 124. The processor 120 registers the request, determines the address of the stored content in memory 116, and retrieves the associated content from the memory 116. Alternatively, the processor 120 registers the request and determines the address of the live broadcast content on another channel. Thereafter, the requested content is transmitted to the display apparatus 140 for presentation to the user.

A trigger is usually initially transmitted with a broadcast during a television commercial. The trigger is, in general, associated with the same type of content as the television commercial is associated with. Thus, if the user is somewhat interested in the type of content of the broadcast television commercial, then the user may further view and interact with the enhanced content stored in memory 116. For example, there may be a number of different types of content stored in the memory 116, one of which is related to clothing. A commercial that is broadcast that also relates to clothing may be broadcast along with a trigger. The trigger may reference the clothing related content stored in memory 116. Alternatively, an actual television broadcast (not a commercial) may be transmitted with a trigger. In this circumstance, the television broadcast may be something related to clothing (i.e., a make-over reality television show), and the same trigger may be transmitted along with the actual television broadcast.

In an alternative embodiment, content may not be stored in long-term storage portion of memory 116. Rather, the content may be transmitted along with the broadcast and the associated trigger. The content associated with the trigger may be stored in a memory buffer such that if the user activates the trigger the associated content can be displayed from the buffer. Otherwise, the content is purged from memory to make room for new content. As can be appreciated, a combination of long-term and short-term memory may be utilized to store content associated with a trigger.

In a further alternative, content may not be stored in the memory 116 of the STB 108 at all. Rather, the processor 120 may request an upstream server for the content associated with the trigger when the trigger is actuated. Therefore, additional memory space on the STB 108 is not occupied by content that may or may not be viewed.

In accordance with at least some embodiments of the present invention, content associated with the trigger may be live content on a different channel. The trigger presented to the user may include a question asking the user if he/she would like to change channels. When the trigger is actuated, the live broadcast is changed from the original channel to the new channel associated with the trigger. Furthermore, the original channel may continue to be displayed to the user is a smaller portion of the display apparatus 140.

In the event the user decides that he/she does not wish to view the content associated with a particular trigger, the resume button 136 on the viewer control interface 128 may be activated to go back to the content that was previously being viewed. Thus, if the user was previously watching a television show when the trigger was activated, he/she may simply press the resume button 136 and the processor 120 will stop displaying the selected content and will resume displaying the previous content. Likewise, the user may navigate through different advertising content and live broadcast content using the select 132 and resume 136 buttons.

Although depicted as separate elements, the display apparatus 140 and STB 108 may be implemented as a single device that comprises a memory 116, processor 120, and display functionality. For example, a cell phone, PDA, Blackberry™, TREO™, or the like may be equipped with the functionality discussed herein to enhance the experience associated with using such a device.

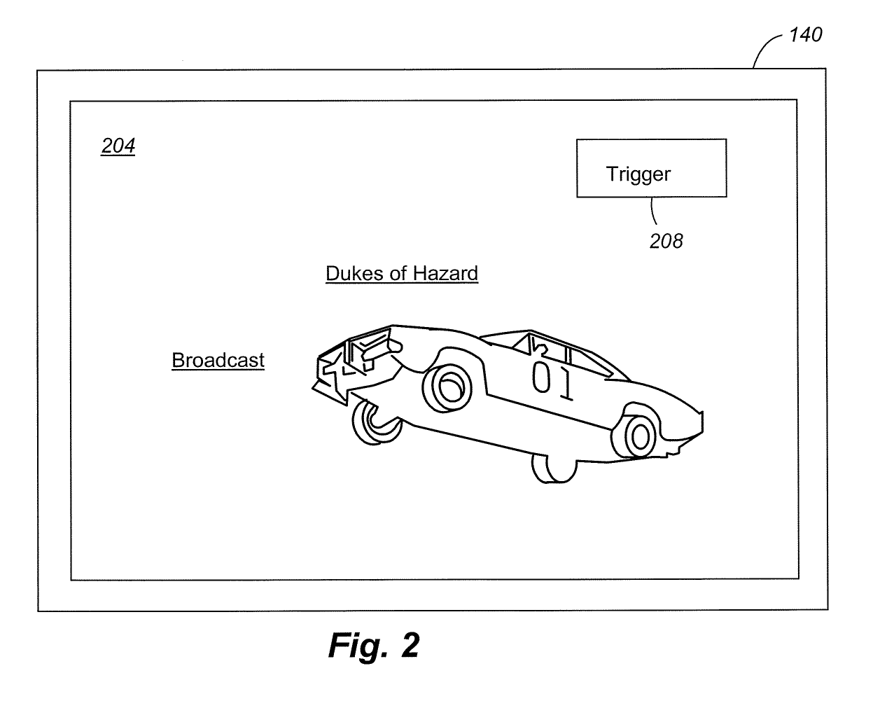

Referring now to FIGS. 2-7 the navigation of content will be described in accordance with embodiments of the present invention. Referring initially to FIG. 2, a display apparatus 140 is shown presenting a live broadcast 204 along with an embedded trigger 208. As noted above, the broadcast 204 may be an advertisement or some other type of content that is presented by a primary content provider. Generally, the broadcast 204 is related to a particular type of content. For example, for the depicted broadcast of The Dukes of Hazard, the type of content could be related to automobiles or machines. Therefore, the trigger 208 displayed with the broadcast 204 may also be associated with content of the same type. Of course, the broadcast may be an advertisement that is presented either nationally, regionally, or locally, and the trigger 208 presented therein may also be related to the same type of content as the advertisement.

The trigger 208 may include a description of the type of content that will be displayed in the event that the trigger is actuated. Assuming a user is somewhat interested in viewing content associated with the presented trigger 208, the user may press the select button 128 that consequently actuates the presented trigger 208.

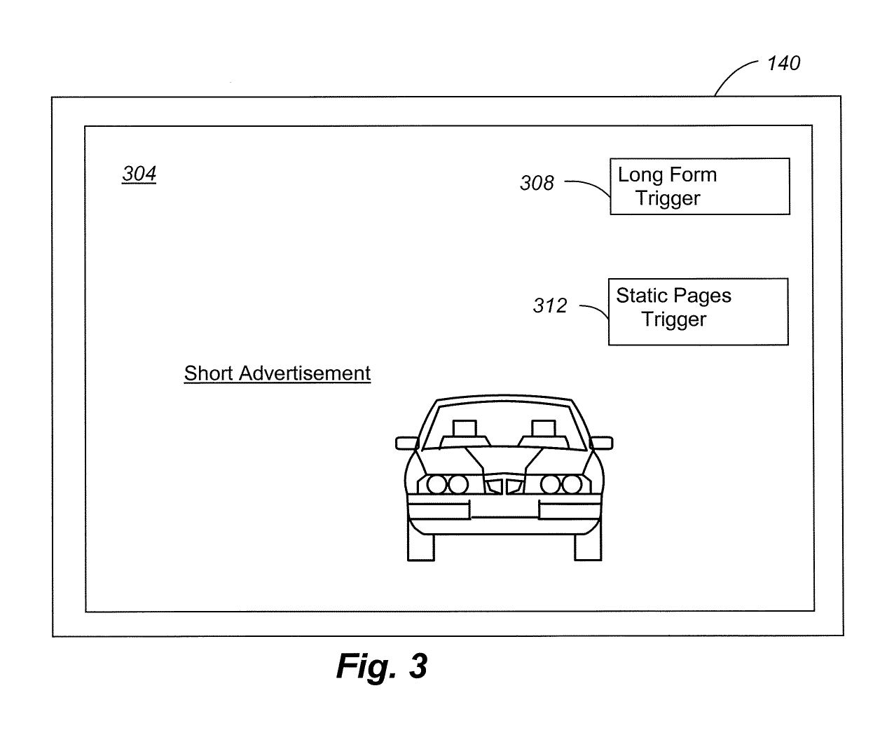

Once the trigger 208 has been actuated, content associated with the trigger 208 is presented to the user via the display apparatus 140. As can be seen in FIG. 3, the associated content is a short form advertisement 304 for a car. The short form advertisement may include about a thirty second or one minute commercial highlighting advantages and features of the product. The short form advertisement is somewhat informative but is mainly designed to peak a viewer's interest in the particular product/service. The short form advertisement 304 may have been retrieved from memory 116, or may have been requested from a content server by the processor 120 when the trigger 208 was actuated.

The presentation of the short form advertisement may further include a number of additional triggers. For example, a long form trigger 308 and a static page trigger 312 may be presented in conjunction with the short form advertisement. Typically, the long form advertisement associated with the long form trigger 308 and the static pages associated with the static page trigger 312 are related to the same type of content as the short form advertisement 304. Often, the triggers lead to additional information for the same product/service that is being displayed by the short form advertisement 304. Additional triggers may also be presented to the user including triggers to alternative short form, long form, live broadcast, or static pages related to similar types of content (i.e., automobiles) but may present a different product/service. Alternatively, the type of content related to the displayed triggers may be completely unrelated to the type of content of the short form advertisement 304.

As the viewer continues to watch the short form advertisement 304 he/she may select one of the triggers 308 or 312 presented therein. The user may have become interested in learning more about the product/service shown in the short form advertisement 304 and therefore may want to learn more about that product/service. In that event the user may select the long form trigger 308. The user may alternatively select the static pages trigger 312 in the event that he/she wants to view static pages about the product/service or even wants to find out where he/she can purchase the product/service.

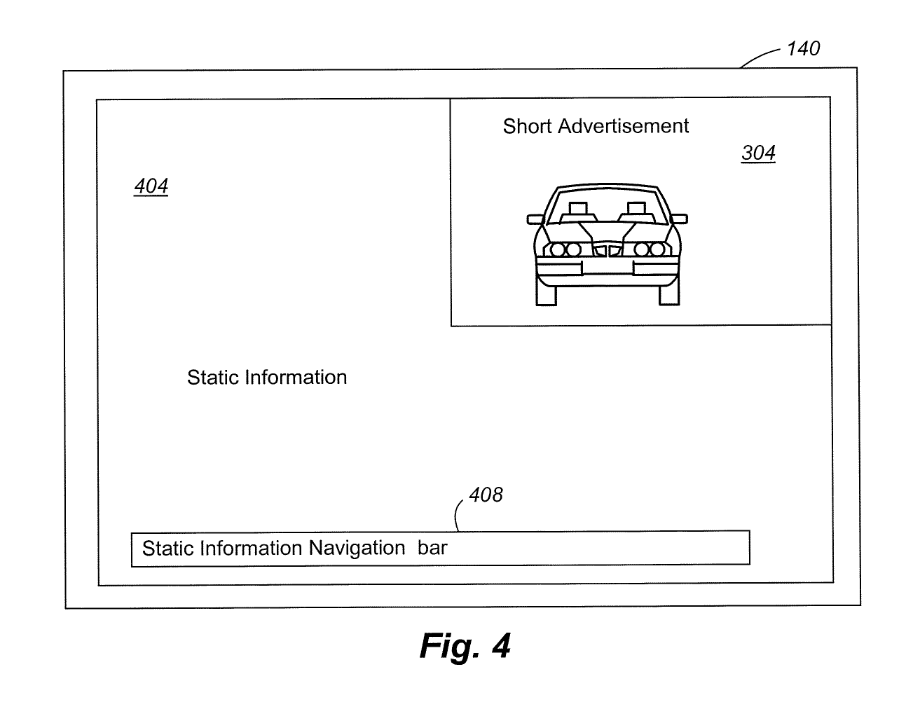

Assuming the user actuates the static page trigger 312, the user is then presented with one or more static pages 404 as can be seen in FIG. 4. The static pages 404 may present detailed information to the user regarding the product/service that is shown in the short form advertisement 304. When the static page trigger 312 is actuated the static information page 404 may be presented along with the short form advertisement 304. The selected content may be displayed on a prominent portion of the display apparatus 140. For example, the selected content (i.e., the static information 404) may be displayed on three-quarters of the screen, whereas the short form advertisement 304 may be displayed on the other quarter of the screen. Simultaneous presentation of contents allows the user to continue viewing the short form advertisement 304 while he/she navigates the static information pages 404. As noted above, the select 132 and resume 136 buttons may be employed by the user to navigate the static pages 404. On the other hand, a navigation bar 408 may be provided with the static information. The navigation bar 408 may include the different static pages that are available for viewing with a number next to it. The user can simply input a number associated with the desired static page and that page will then be presented. In the event that the user input 124 comprises a keyboard, mouse, or the like, the user simply selects which page he/she wants to view by, for example, placing the pointer over the desired page and pressing the mouse button.

The static pages 404 presented to the user may be personalized to the user based on the region where the user resides, user input and personal information, and/or any other information that has been gleaned from monitoring the user. For example, static pages 404 may be presented to a user showing him/her where the closest car dealerships are for the advertised car. Additionally, the static pages 404 may present a map or directions to the user on how to get to the dealership from the user's house. The static pages 404 may also be personalized based upon user preferences. For example, if the user has expressed an interest in convertible cars in the past, the static pages 404 may present various convertibles that are similar to the car in the short form advertisement 304.

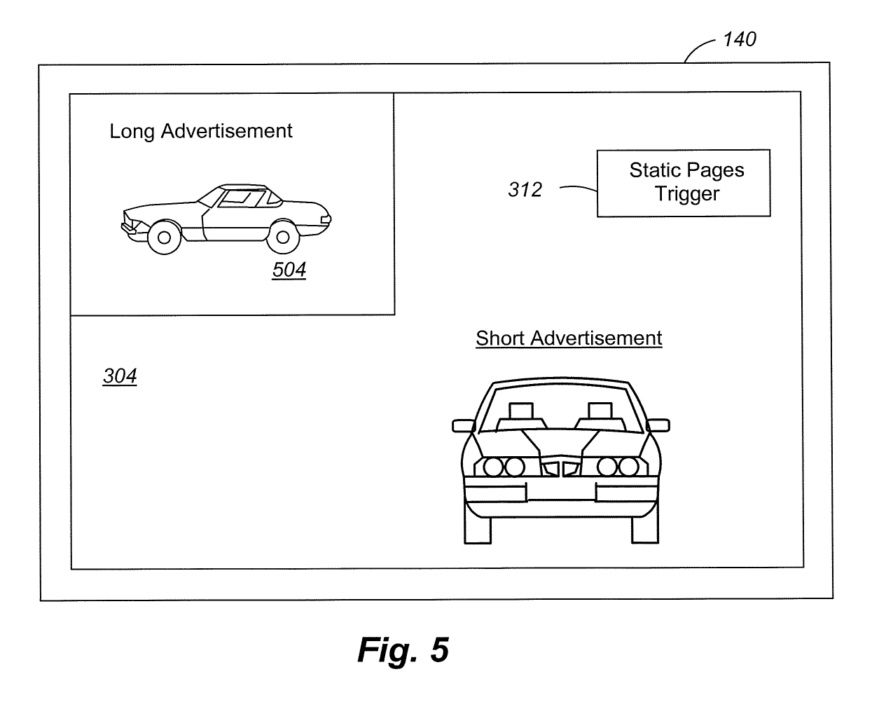

Alternatively, the user may have selected the long form trigger 308 when the short form advertisement 304 was presented. In that event, the user may be presented with the short form advertisement 304 at substantially the same time as the long form advertisement 504 as can be seen in FIG. 5. Although the long form advertisement 504 is depicted as occupying about a quarter of the display apparatus 140, the content associated with a selected trigger is typically displayed on the prominent portion of the display apparatus 140. However, the selected portion may be displayed on the smaller portion of the display apparatus 140.

The long form advertisement 504 is typically a longer more informative version of the short form advertisement 304 for the same product/service, although the long form advertisement 504 does not need to be directed toward the same product/service or even the same type of content.

In accordance with at least one embodiment, a user selects the long form advertisement 504 to learn more about the displayed product/service. The long form advertisement 504 may include a number of different facts and may discuss the features of the product/service in much greater detail than the short form advertisement 304. By displaying the long 504 and short 304 form of the advertisement, the user is able to learn a great amount about a product/service in a short amount of time and the products/services being advertised can achieve greater exposure at the same. Additional triggers (i.e., the static page trigger 312) may be displayed to the user while the long 504 and short 304 form advertisements are simultaneously displayed to the user.

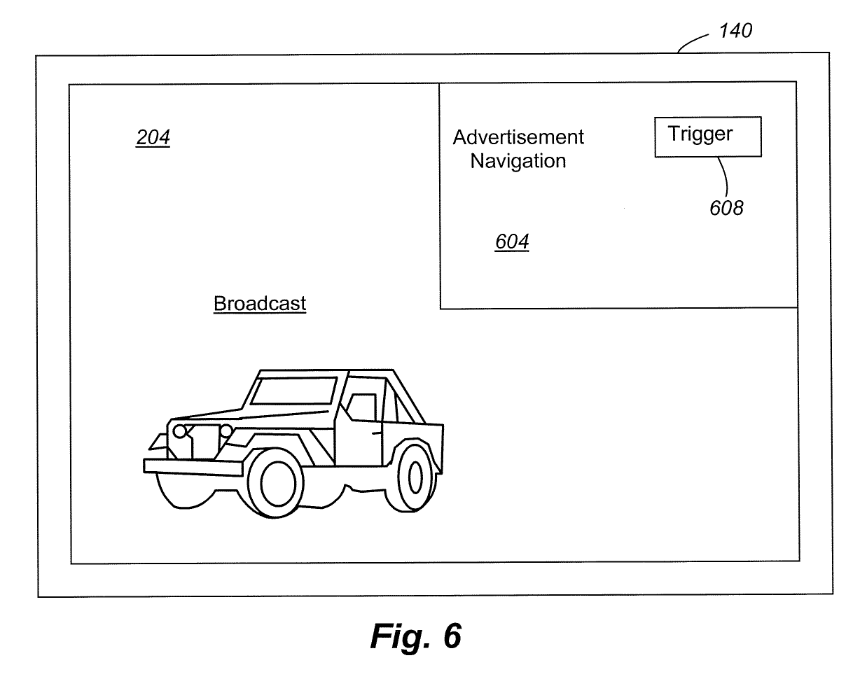

Referring to FIG. 6 a trigger 608 may be displayed within the smaller portion of advertisement content 604 while a broadcast 204 is continually displayed in the larger portion of the display apparatus 140. The advertisement content 604 may include a short form advertisement, a long form advertisement, static pages, a live broadcast, and the like. A user is able to navigate advertisement content 604 in a similar fashion to navigating a full screen of advertisement content through the use of triggers and the like, except the advertisement content 604 does not completely supersede the live broadcast 204. This may be accomplished by presenting the user with alternative triggers. The first trigger may allow the user to view a full screen of advertisement content 604 and the second trigger may allow the user to view a smaller version of advertisement content 604 while continuing to view the current broadcast 204. This particular feature provides the user with options that can further personalize the viewing experience. In the event that the user wishes to view a smaller version of the advertising content 604, triggers 608 may be provided that only control the content viewed in the smaller portion of the screen.

In accordance with one embodiment of the present invention, by allowing the user to view multiple contents at the same time, a user is able to choose whether he/she wishes to view a live broadcast and a previously stored content at substantially the same time, two different previously stored contents at substantially the same time, one content stored in short term memory and a second content stored in long term memory, and/or one or more live broadcasts that are not stored in memory.

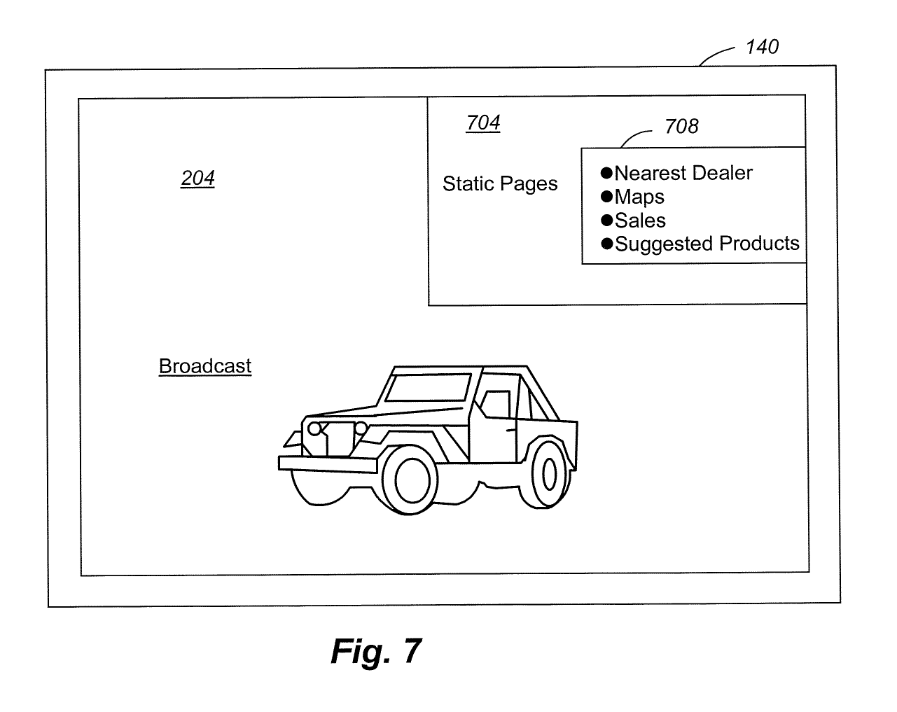

As can be seen in FIG. 7 the user may navigate different contents, for example, static pages 704 while he/she continues to view the live broadcast 204. The static pages 704 may include personalized content 708 that further enhances the viewer experience. Examples of personalized content 708 include, but are not limited to, a nearest product/service dealer, maps, sales information, and suggested products/services related to the product/service that is currently being viewed. The personalized content 708 may be customized based on input information from the user (e.g., age, gender, marital status, hobbies, likes, dislikes, etc.) Alternatively, the personalized content 708 may be customized based on information recovered during the monitoring of a user's actions (e.g., product preferences, TV show preferences, viewing schedule, viewing frequency, etc.)

The content that is stored in memory 116 and then subsequently displayed to the viewer at a later time may be replaced with different content based upon recovered information about the user (i.e., input information or monitored information). For example, if it is determined that the user prefers to watch sporting events as opposed to situational comedies, then sports related content may transmitted from the head end 104 to the STB 108 to be stored in memory 116 in place of other content that may appeal to a user who watches more situational comedies. Optimizing the number of contents in memory 116 that the user may be interested in helps to increase the odds with which a user will choose to view a particular advertising content 604. Moreover, if triggers to content are only displayed when a related show or advertisement is shown, more content will be available from memory 116 that relates to what the user typically views. This can increase the number of triggers that will be presented to the user, which in turn helps to increase market exposure of different products/services. As can be appreciated by one of skill in the art, the targeting and optimization of content for a particular user can help increase the chances of a sale based on viewing a particular advertisement, since it is more likely that a product/service will be presented to a user that might have an interest in such a product/service.

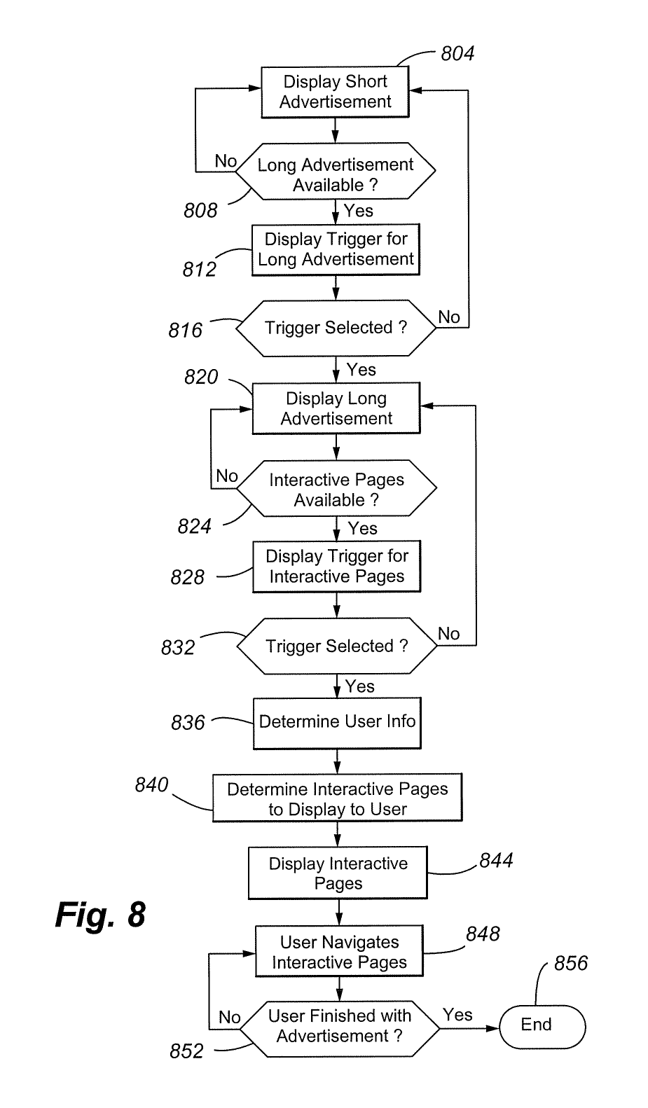

Referring now to FIG. 8 a method of presenting content to a user will be described in accordance with at least some embodiments of the present invention. Initially a short form advertisement is displayed to a user (step 804). Typically, the short form advertisement is displayed as a result of the actuation of a trigger that was presented during a live broadcast. Some time before or during the display of the short form advertisement, it is determined if a long form advertisement is available that is somewhat related to the short form advertisement or if a different live broadcast is available that is somewhat related to the short form advertisement (step 808). A long form advertisement may be related to the short form advertisement if the two advertisements are directed toward the same product/service, are related to the same company, or have a similar content type (i.e., both are related to makeup). Similarly, a live broadcast may be related to the short form advertisement if the advertisement is for a particular show that is currently being transmitted on a different channel. If no related long form advertisement is available, then the method returns to step 804 and the short form advertisement continues to be displayed to the user. However, if a related long form advertisement is available, then a trigger is displayed along with the short form advertisement that comprises a link or memory location to the long form advertisement/live broadcast (step 812). Thereafter, the method waits until the trigger is selected (step 816). In the event that the trigger to the long form advertisement/live broadcast is not selected, then the method returns to step 804 and the short form advertisement continues to be displayed.

If the trigger associated with the long form advertisement is selected or otherwise actuated, then the long form advertisement is displayed to the user (step 820). As can be appreciated, the long form advertisement may be displayed at substantially the same time as the short form advertisement or it may simply be displayed by itself. As the long form advertisement is being displayed (or after the trigger was actuated but before the long form advertisement is displayed) it is determined if any related interactive pages are available for viewing (step 824). In the event that no interactive pages are available for viewing, the method returns to step 820 and the long form advertisement continues to be displayed, whether by itself or with another short form advertisement. However, in the event that interactive static pages are available, a trigger or number of triggers are displayed along with the long form advertisement (step 828). As the user views the long form advertisement with the accompanying trigger to static interactive pages, the method waits until the trigger is selected (step 832). If the trigger is not selected, the long form advertisement continues to be displayed in step 820. However, if the trigger associated with the static interactive pages is actuated, then user information is determined (step 836). As noted above, user information that may be determined includes, but is not limited to, user input information like gender, race, likes, dislikes, hobbies, age, marital status, and other interests, monitored information like product preferences, TV show preferences, viewing schedule, viewing frequency, and purchase history, and location or regional information.

Based on the determined user information, the types of static pages that will be displayed to the user are determined (step 840). Static pages are basically chosen in an attempt to maximize the users viewing experience while increasing the likelihood that the user may be interested in purchasing the product/service. For example, for a single product, like an automobile, there may be two categories of static pages. One set of static pages for males and a second set of static pages for females. The static pages may all be directed toward the same exact model of automobile (i.e., the BMW® 3 Series). However, the set of static pages aimed at male viewers may highlight certain aspects of the vehicle that a male might be more interested in like engine specifics and performance data. On the other hand, the set of static pages aimed at female viewer may highlight certain aspects of the vehicle that a female might be more interested in like cockpit design and safety. If it is determined that the viewer is a female, then the corresponding female set of static pages may be displayed to the user.

As can be appreciated by one of skill in the art, the customization of content is not confined to static pages. Rather, there may be customized short form advertisements that target a specific user. These customized short form advertisements may be designed to peak the interest of a particular viewer, and the long form advertisements may be customized to highlight those aspects of the product/service that the user may find appealing.

In step 844, the interactive page(s) are displayed to the user along with or in replacement of the short form and/or long form advertisement. The user is then able to navigate the interactive pages through the use of triggers or by way of the navigation bar 408 (step 848). In step 852 it is determined if the user is finished viewing the advertisement. If the user continues to view the advertisement or continues to navigate the static pages then the method returns to step 848. Once the user is done viewing the advertisement content the method ends in step 856.

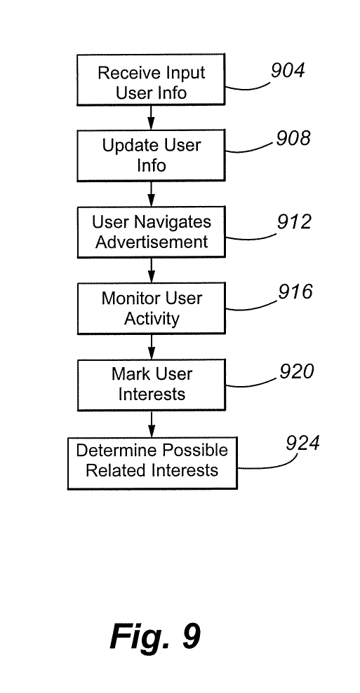

Referring now to FIG. 9, a method of determining user information will be described in accordance with at least some embodiments of the present invention. Typically, the first information that is determined about a user is any information that he/she inputs into the system. The input user information is received by the user input 124 of the STB 108 (step 904). The received input information may include general information like address, age, gender, race, interests, and so on. The received input information is then sent to the memory 116 where it is stored (step 908). Additionally, the user information may be transmitted from the STB 108 to a content server or database such that customized content can be transmitted from the content server to the subject STB 108.

Additional information may be collected as the user navigates either television broadcasts or advertisement content. In step 912, the user navigates advertisement content either through the use of triggers or through a navigation bar 408 if one is provided. While the user navigates content, the STB 108 monitors the activity of the user (step 916). The activities that may be monitored include, but are not limited to, channel selection, content selection, viewing frequency, viewing schedule, and so on. Based on the monitored activity, user interests may be further determined and marked (step 920). The determined interests may also be stored in the memory 116 and/or sent to a content server for further evaluation of the user's potential interests. Based on the accumulation of information from the user, the STB 108 and/or a content server may make a determination of possible related interests for the given user and may further determine what types of content to provide to the STB 108 for possible future display (step 924).

In accordance with one embodiment of the present invention, content may be stored in memory 116 for a predetermined amount of time. Once the predetermined amount of time has lapsed, new content may be transmitted to the STB 108 to replace the expired content. Likewise, if a user continues to express an interest in only certain types of contents, the server may transmit new content to the STB 108 to replace content that has a lower possibility of being viewed by the user.

As noted above, the determined user information may be used not only to customize static pages or the like for viewing by the user, but determined user information may be employed to customize short and long form advertisements that are presented to the user. Specifically, determined user information can be applied to selecting different contents that should be sent to a specific STB 108, which may result in an increased viewership of advertisements for products/services.

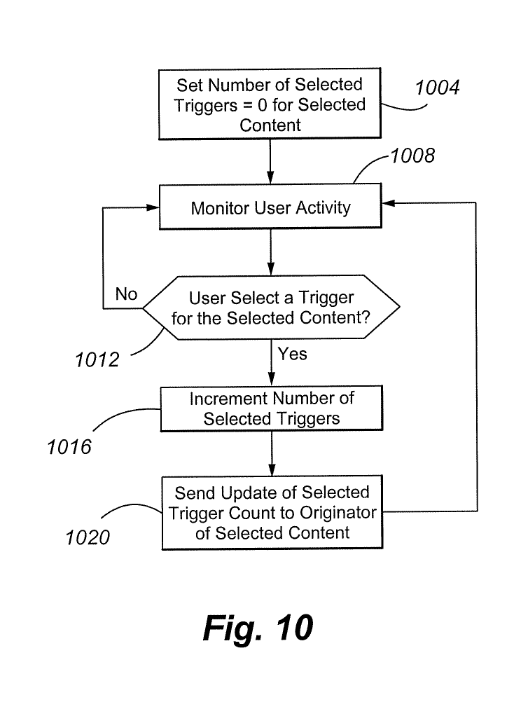

Referring now to FIG. 10 a method of counting trigger action for a selected trigger and/or for a selected content or content type will be described in accordance with at least some embodiments of the present invention. Initially, a variable representing the number of selected triggers is initialized and set equal to zero (step 1004). The selected trigger may be associated with a particular advertising campaign for a new product like a soft drink or a particular television channel. Thus, the selected trigger may actually be a number of triggers (i.e., triggers to live content, triggers to long form advertisements, triggers to short form advertisements, triggers to static pages, etc.) each associated with the same soft drink. Alternatively, the selected trigger may be more specifically associated with a short form advertisement for a particular product.

Once the selected trigger is determined, the activity associated with the selected trigger is monitored for all users (or their respective STBs 108) to whom the trigger has been or may be sent (step 1008). In step 1012, it is determined if a user has selected or otherwise actuated the selected trigger (step 1012). In the event that the user has not actuated the selected trigger, the method returns to step 1008 where user activity is monitored for the selected trigger. However, in the event that the selected trigger is actuated, the variable corresponding to the number of selected triggers is incremented (step 1016). The notice of a selected trigger is typically sent from a STB 108 to a content server or other type of server where the count for all user activity is monitored. After a predetermined amount of time, when a certain number of triggers have been actuated, or after each actuation of the trigger, an update of the selected trigger count is sent to the originator of the selected trigger or the content associated with the selected trigger. For example, if company X has recently launched an advertisement campaign for a new set of basketball shoes, the update of selected triggers associated with that advertising campaign can be sent to company X at the determined point in time or after the count has reached a certain level. This allows the update process to be automated between the counting server and an information server associated with company X. Moreover, if a live count is desired, company X may be given access to the counting server or a continuous link between the counting server and company X's server may be implemented such that real-time updates are possible.

The foregoing discussion of the invention has been presented for purposes of illustration and description. Furthermore, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best modes presently known of practicing the invention and to enable others skilled in the art to utilize the invention in such, or in other embodiments, and with the various modifications required by their particular application or use of the invention. It is intended that the appended claims be construed to include alternative embodiments to the extent permitted by the prior art.

What is claimed is:

1. A method of administering interactive media to a user, comprising:
presenting a first trigger to the user, wherein the first trigger is associated with a first content;
receiving a request to view the first content by actuation of the first trigger;
causing the first content to be presented to the user;
presenting a second trigger to the user within the first content, wherein the second trigger is associated with a second content;
receiving a request to view the second content by actuation of the second trigger; and
causing the second content to be presented to the user at substantially the same time as the first content.

2. The method of claim 1, further comprising:
presenting a third trigger to the user within at least one of the first and second displayed content, wherein the third trigger is associated with a third content;
receiving a request to view the third content; and
performing at least one of the following:
(i) replacing the first content with the third content;
(ii) replacing the second content with the third content; and
(iii) causing the third content to be present to the user at substantially the same time as the first and second content.

3. The method of claim 1, wherein the first content comprises a short form advertisement and wherein the second content comprises a long form advertisement.

4. The method of claim 1, wherein at least one of the first and second content comprise at least one of a short form advertisement, a long form advertisement, a broadcast, a static advertisement page, and a personalized advertisement.

5. The method of claim 1, further comprising:
receiving user information;
determining a type of content that may be of interest to the user based on the received user information; and
incorporating the type of content into at least one of the first and second displayed content.

6. The method of claim 1, wherein the first content is displayed on a first portion of a display apparatus and wherein the second content is displayed on a second portion of the display apparatus.

7. The method of claim 6, wherein the first portion is about a quarter of the total size of the display apparatus and wherein the second portion is about three-quarters of the total size of the display apparatus.

8. The method of claim 6, wherein the first portion at least partially overlaps the second portion.

9. The method of claim 1, wherein the first trigger is presented to the user in response to receiving a broadcast related to a type of content, and wherein the first content comprises the related type of content.

10. The method of claim 9, wherein the second content also comprises the related type of content.

11. The method of claim 1, wherein the first and second content are presented to the user via at least one of a television, personal digital assistant, computer, and cellular phone.

12. The method of claim 1, further comprising:
counting the number of times the first trigger is actuated; and
sending the count of the number of times the first trigger has been actuated to an entity associated with at least one of the first trigger and first content.

13. A system for administering interactive media to a user, comprising:
a receiver operable to receive broadcast signals;
a first trigger associated with a first content, wherein the first content further comprises a second trigger associated with a second content; and
a display apparatus operable to display a user-perceptible form of the first and second content at substantially the same time in response to the receiver receiving a request from the user to view the first and second content, whereby the request is received by actuation of the first and second triggers.

14. The system of claim 13, wherein the display apparatus is further operable to present a third trigger to the user within at least one of the first and second displayed content, wherein the third trigger is associated with a third content, and wherein the receiver if further operable to receive a request to view the third content and cause at least one of the following to occur:
(i) replace the first content with the third content;
(ii) replace the second content with the third content; and
(iii) cause the third content to be presented to the user at substantially the same time as the first and second content.

15. The system of claim 13, wherein the first content comprises a short form advertisement and wherein the second content comprises a long form advertisement.

16. The system of claim 13, wherein at least one of the first and second content comprise at least one of a short form advertisement, a long form advertisement, a broadcast, a static advertisement page, and a personalized advertisement.

17. The system of claim 13, wherein the receiver is further operable to receive user information, determine a type of content that may be of interest to the user based on the received user information, and incorporate the type of content into at least one of the first and second displayed content.

18. The system of claim 13, wherein the first content is displayed on a first portion of a display apparatus and wherein the second content is displayed on a second portion of the display apparatus.

19. The system of claim 18, wherein the first portion is about a quarter of the total size of the display apparatus and wherein the second portion is about three-quarters of the total size of the display apparatus.

20. The system of claim 18, wherein the first portion at least partially overlaps the second portion.

21. The system of claim 13, wherein the first trigger is presented to the user in response to receiving a broadcast related to a type of content, and wherein the first content comprises the related type of content.

22. The system of claim 21, wherein the second content also comprises the related type of content.

23. The system of claim 13, wherein the first and second content are presented to the user via at least one of a television, personal digital assistant, computer, and cellular phone.

24. The system of claim 13, wherein the receiver is further operable to count the number of times that at least one of the first trigger and second trigger has been actuated, and convey that count to an enterprise associated with at least one of the first content, first trigger, second content, and second trigger.

25. A system for administering interactive media to a user, comprising:
a first trigger means associated with a first content;
a second trigger means associated with a second content; and
a display means operable to display the first content and the second trigger means upon actuation of the first trigger means, and further display the second content along with the first content upon actuation of the second trigger means.

26. The system of claim 25, wherein the first content comprises a short form advertisement and wherein the second content comprises a long form advertisement.

27. The system of claim 25, wherein at least one of the first and second content comprise at least one of a short form advertisement, a long form advertisement, a broadcast, a static advertisement page, and a personalized advertisement.

28. The system of claim 25, wherein the receiver is further operable to receive user information, determine a type of content that may be of interest to the user based on the received user information, and incorporate the type of content into at least one of the first and second displayed content.

29. The system of claim 25, wherein the display means is partitioned into at least two portions, wherein the display means if further operable to display the first content on a first portion and the second content on a second portion.

30. The system of claim 29, wherein the first portion is about a quarter of the total size of the display means and wherein the second portion is about three-quarters of the total size of the display means.

31. The system of claim 29, wherein the first portion at least partially overlaps the second portion.

32. The system of claim 25, wherein the first trigger means is presented to the user in response to receiving a broadcast related to a type of content, and wherein the first content comprises the related type of content.

33. The system of claim 32, wherein the second content also comprises the related type of content.

34. The system of claim 25, wherein the display means comprises at least one of a television, personal digital assistant, computer, and cellular phone.

35. The system of claim 25, further comprising a means for counting the number of times at least one of the first and second trigger means has been actuated, wherein the means for counting is further operable to convey the count to an enterprise associated with at least one of the first trigger means, first content, second trigger means, and second content.
